(19) United States
(12) Patent Application Publication
(10) Pub. No.: US 2010/0000947 A1
(43) Pub. Date: Jan. 7, 2010

(54) TREATING METHOD OF A FLUORINATED SURFACTANT-CONTAINING AQUEOUS SOLUTION

(75) Inventors: Michinobu KOIZUMI, Osaka (JP); Yasuhide Senba, Osaka (JP); Hideya Saitou, Osaka (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD., Osaka (JP)

(21) Appl. No.: 12/496,865

(22) Filed: Jul. 2, 2009

(30) Foreign Application Priority Data
Jul. 4, 2008 (JP) 2008-175444
Dec. 9, 2008 (JP) 2008-313575

(51) Int. Cl. C02F 1/28

(52) U.S. Cl. 210/694

(57) ABSTRACT

The present invention provides a treatment method by which a fluorinated surfactant such as PFOA can be removed from water very efficiently. The treatment method includes a step (1) of contacting a water to be treated containing 100 to 10000 ppb of a fluorinated surfactant with an activated carbon and a step (2) of obtaining a treated water containing not more than 3.0 ppb of the fluorinated surfactant. The activated carbon comprises the particles capable of passing through a 75-μm filter of not smaller than 90% by mass of the total particles.

### CROSS-REFERENCE TO RELATED APPLICATIONS

The present application claims priority under 35 U.S.C. §119 to Japanese Patent Application No. 2008-175444, filed Jul. 4, 2008 and Japanese Patent Application No. 2008-313575, filed Dec. 9, 2008, the contents of which are incorporated herein by reference in their entirety.

### TECHNICAL FIELD

The present invention relates to a treating method of an aqueous solution containing a fluorinated surfactant.

### BACKGROUND ART

Perfluorooctanoic acid [PFOA] and perfluorooctanesulfonic acid [PFOS] are used as surfactants in fluoropolymer production processes, among others.

The results of a recent study (EPA Report “Preliminary Risk Assessment of the Developmental Toxicity Associated with Exposure to Perfluorooctanoic Acid and its Salts”, among others, have revealed that PFOA may possibly act as an environmental contamination. On Apr. 14, 2003, the EPA (United States Environmental Protection Agency) announced its intention to intensify the scientific investigation on PFOA.

Patent Document 1 discloses a recovering method of PFOA using a granular activated carbon.

### CITATION LIST

### Patent Literature

### {Patent Document 1} United States Patent Application Publication 2005/0000904

### SUMMARY OF INVENTION

### Technical Problem

A method using an activated carbon is highly advantageous from an economical viewpoint but is unsatisfactory from a treatment efficiency viewpoint so long as the conventional techniques are used. In view of such state of the art, it is an object of the present invention to provide a treatment method by which fluorinated surfactants such as PFOA can be removed very efficiently.

### Solution to Problem

The present invention is a treatment method comprising a step (1) of contacting a water to be treated containing 100 to 10000 ppb of a fluorinated surfactant with an activated carbon and a step (2) of obtaining a treated water containing not more than 3.0 ppb of the fluorinated surfactant, wherein the activated carbon comprises particles capable of passing through a 75-μm filter of not smaller than 90% by mass of the total particles.

In the following, the invention is described in detail.

The present invention is a treatment method comprising a step (1) of contacting a water to be treated containing 100 to 10000 ppb of a fluorinated surfactant with an activated carbon and a step (2) of obtaining a treated water containing not more than 3.0 ppb of the fluorinated surfactant.

As a result of intensive investigations, the present inventors found that when the fluorinated surfactant concentration in a water to be treated is low, the conventional art which uses a granular activated carbon has its limits in reducing the fluorinated surfactant concentration even when the activated carbon is used in large amounts, whereas a use of an activated carbon having specific physical characteristics makes it possible to realize a very highly efficient treatment.

It is well known that the performance characteristics of an activated carbon generally depend on the specific surface area thereof. Surprisingly, however, an efficiency of treatment of an aqueous solution having a low fluorinated surfactant concentration greatly depends on the particle diameter of the activated carbon and has no correlation with the specific surface area thereof.

Thus, the present invention makes it possible to efficiently remove any fluorinated surfactant even from a water to be treated having a fluorinated surfactant content of not higher than 10000 ppb and thereby give an almost fluorinated surfactant-free treated water by using an activated carbon in such a powder form that the particles capable of passing through a 75-μm filter is not smaller than 90% by mass of the total particles.

The step (1) is a step of contacting a water to be treated containing 100-10000 ppb of a fluorinated surfactant with such an activated carbon as specified above.

When the water to be treated has a fluorinated surfactant concentration exceeding 10000 ppb, it becomes economically disadvantageous to treat such a water and, when that concentration is below 100 ppb, the treatment efficiency becomes low. A preferred lower limit to the fluorinated surfactant concentration is 200 ppb, and a more preferred lower limit thereof is 500 ppb. A preferred upper limit to the fluorinated surfactant concentration is 1000 ppb and a more preferred upper limit thereto is 800 ppb.

Even when the water to be treated has a fluorinated surfactant concentration of 10000 ppb or lower or, further, even when it is 1000 ppb or lower, the treatment method of the invention can remove the fluorinated surfactant with high efficiency.

When the water to be treated or the treated water has a fluorinated surfactant concentration of 1000 ppb or lower, the fluorinated surfactant concentration, so referred to herein, is a value measured by using liquid chromatograph-tandem mass spectrometer (LC/MS/MS) (manufactured by Waters Corporation)

HPLC system main unit: model 2695 separation module
Mobile phase solvent: acetonitrile 45% by volume/0.15% aqueous acetic acid solution 55% by volume
HPLC column: Atlantis dC18 3 μm, 2.1×30 mm
Tandem quadrupole mass spectrometer: Quattro micro API

When the water to be treated or the treated water has a fluorinated surfactant concentration exceeding 1000 ppb, the fluorinated surfactant concentration, so referred to herein, is a value measured by high-performance liquid chromatography (HPLC).

HPLC system main unit: Hitachi High-Technologies Corporation/D-2000 Elite HPLC system
Mobile phase solvent: acetonitrile 50% by volume/60% aqueous perchloric acid solution 0.5% by volume/water 49.5% by volume
HPLC column: Tosoh Corporation/TSK-GEL ODS-120T, 4.6×150 mm

The activated carbon may be one obtained from such a raw material as sawdust, wood chips, charcoal, bamboo charcoal, grass peat (peat), coconut shell charcoal, coal (e.g. lignite, brown coal, bituminous coal, anthracite), phenol resins, rayon, acrylonitrile, coal pitch, petroleum pitch, or phenolic resins.

The water to be treated may be contacted with the activated carbon in a batchwise manner by adding the activated carbon to the water to be treated or in a continuous manner by passing the water to be treated through a column packed with the activated carbon, or by repeating the batchwise contact treatment or the continuous contact treatment a plurality of times, or by combining the batchwise contact treatment with the continuous contact treatment. The packed column for the continuous contact processes may be of a moving bed, fixed bed, or fluidized bed type.

In the batchwise manner, although the contact time of the water to be treated and the activated carbon may be properly adjusted according to an amount of the activated carbon, a desired surfactant concentration and the like, the time is preferably not less than 60 minutes from a viewpoint of a removal efficiency.

From a viewpoint of securing a satisfactory level of treatment efficiency, the activated carbon is preferably added in an amount of at least 0.015% by mass relative to the water to be treated. The level of addition of the activated carbon is more preferably not lower than 0.05% by mass, still more preferably not lower than 0.10% by mass.

The fluorinated surfactant is not particularly restricted but may be any fluorine atom-containing compound that shows surface activity. Preferably, however, it comprises at least one species selected from a group consisting of perfluorooctanoic acid, perfluorooctanoic acid salts, perfluorooctanesulfonic acid and perfluorooctanesulfonic acid salts. The perfluorooctanoic acid salts and perfluorooctanesulfonic acid salts include the corresponding ammonium salts and alkali metal salts.

The water to be treated is not particularly restricted but may be the fluorinated surfactant-containing aqueous solution, which is an aqueous solution used in a fluoropolymer production process, or waste water discharged from such production process. The water to be treated may also be ordinary tap water or natural water. Further, the water to be treated may contain a solid matter. When, however, it contains a large amount of a solid matter and it is feared that the treatment efficiency may be affected thereby, the step (1) is preferably preceded by a step of removing the solid matter by filtration, for instance.

When the aqueous solution having the fluorinated surfactant content exceeding 1000 ppb, it is preferred, from the economic efficiency viewpoint, that a pretreatment step be included in the step (1) for purifying the aqueous solution to give a water to be treated having the fluorinated surfactant content of not higher than 1000 ppb. The above purification can be carried out in the conventional manner using an activated carbon in granular form.

The step (2) is a step of obtaining a treated water containing not more than 3.0 ppb of the fluorinated surfactant

The above step (2) is preferably a step of obtaining a treated water having the fluorinated surfactant content of not higher than 1.0 ppb, more preferably a step of obtaining a treated water having the fluorinated surfactant content of not higher than 0.6 ppb, still more preferably a step of obtaining a treated water having the fluorinated surfactant content of not higher than 0.5 ppb. Especially, the step (2) is even more preferably a step of obtaining a treated water having the fluorinated surfactant content of not higher than 0.4 ppb so as to satisfy a standard value recommended by the United States Environmental Protection Agency.

When the treated water contains the activated carbon, the step (2) may include a removal step of the activated carbon. The removal method is not restricted, but there may be mentioned, for instance, a conventional method such as filtration, sedimentation, centrifugal separation, separation by using a flocculant.

The treatment method of the invention can be suitably utilized for a treatment and purification of a waste water discharged from factories, among others.

### ADVANTAGEOUS EFFECTS OF INVENTION

The treatment method of the invention, which has the constitution described above, makes it possible to obtain a fluorinated surfactant-free treated water from a fluorinated surfactant-containing water to be treated with very high efficiency. Such effect of the present invention becomes remarkable especially when the fluorinated surfactant concentration in the water to be treated is low.

### BRIEF DESCRIPTION OF DRAWINGS

{FIG. 1} This is a graph representing the relation between the activated carbon concentration and the PFOA concentration in the treated water.

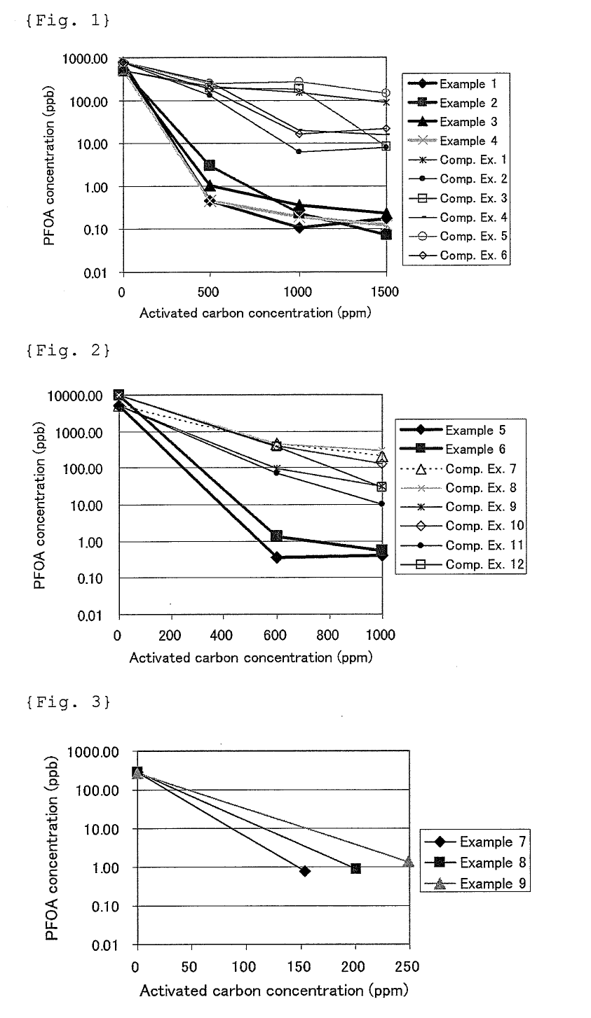

{FIG. 2} This is a graph representing the relation between the activated carbon concentration and the PFOA concentration in the treated water.

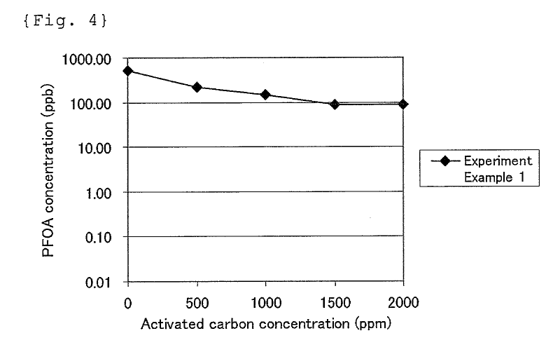

{FIG. 3} This is a graph representing the relation between the activated carbon concentration and the PFOA concentration in the treated water.

{FIG. 4} This is a graph representing the relation between the granular activated carbon concentration and the PFOA concentration in the treated water when the level of addition of the activated carbon is increased.

### DESCRIPTION OF EMBODIMENTS

The following examples, inclusive of comparative examples, illustrate the present invention. These examples are, however, by no means limitative of the scope of the invention.

### Example 1

The activated carbon (product of Japan EnviroChemicals, Ltd., trademark: Shirasagi DO-2) having the number of particles not larger in particle size than 200 mesh (sieve opening 0.075 mm) of not smaller than 90% by mass of the total particles (hereinafter particles satisfying such requirement are referred to as “powder”) and having the specific surface area of 940 m²/g was subjected to the following pretreatment and then used for the treatment of the aqueous solution of PFOA.

### Pretreatment of the Activated Carbon

The activated carbon was placed in a glass vessel and dried in a forced convection oven adjusted to 115° C. for 3 hours. The dried activated carbon was allowed to cool in a desiccator (desiccating agent used: silica gel).

### Preparation of the Aqueous Solution of PFOA

PFOA (product of Aldrich Chemical Company; purity 96%) was dissolved in tap water to give the aqueous solution having the PFOA concentration of 786.2 ppb.

### Treatment of the Aqueous PFOA Solution

The aqueous PFOA solution (100 g) was placed in each of three 200-ml narrow-mouthed polyethylene bottles, and the activated carbon was added to all of the bottles in the respective amounts specified in Table 3. The bottles containing the activated carbon-containing aqueous PFOA solutions were shaken for 168 hours (7 days) in a constant-temperature room maintained at 25° C. using a shaker (product of Iuchi Seieido Co., Ltd./name of article: shaking bath/model SB-20) set at a shaking speed of 150 rpm for allowing the PFOA to be adsorbed on the activated carbon.

The polyethylene bottles were allowed to stand, the supernatants were collected and each was passed through a filter (pore diameter 0.20 μm; Advantec Toyo Kaisha, Ltd./disposable membrane filter/model 13CP020AN). The PFOA concentration in each filtrate was determined by the method described later herein.

### Examples 2 to 6 and Comparative Examples 1 to 12

The procedure of Example 1 was repeated in the same manner except that the activated carbons specified in Table 1 or Table 2 were used in lieu of the above-mentioned activated carbon and that the concentration of the aqueous PFOA solution was varied as given in Table 3 or Table 4. The results obtained in the examples and comparative examples are shown in Table 3 and Table 4 as well as in FIG. 1 and FIG. 2.

### PFOA Concentration Determination (1)

In cases where the PFOA concentration in the water to be treated or the treated water was 1000 ppb or below:

The measurements were made using liquid chromatograph-tandem mass spectrometer (LC/MS/MS) (manufactured by Waters Corporation).

HPLC system main unit: model 2695 separation module
Mobile phase solvent: acetonitrile 45% by volume/0.15% aqueous acetic acid solution 55% by volume
HPLC column: Atlantis dC18 3 μm, 2.1×30 mm
Tandem quadrupole mass spectrometer: Quattro micro API

### PFOA Concentration Determination (2)

In cases where the PFOA concentration in the water to be treated or the treated water was in excess of 1000 ppb:

The measurements were made by high-performance liquid chromatography (HPLC).

HPLC system main unit: Hitachi High-Technologies Corporation/D-2000 Elite HPLC system
Mobile phase solvent: acetonitrile 50% by volume/60% aqueous perchloric acid solution 0.5% by volume/water 49.5% by volume
HPLC column: Tosoh Corporation/TSK-GEL ODS-120T, 4.6×150 mm

TABLE 1

| | | | | | Specific surface |
|---|---|---|---|---|---|
| | Trade name | Manufacturer | Raw material | Form | area (m²/g) |
| Example 1 | Shirasagi DO-2 | Japan EnviroChemicals | Coconut | Powder | 940 |
| Example 2 | 6MD | Calgon Mitsubishi Chemical | Wood | Powder | 981 |
| Example 3 | 6MW | Calgon Mitsubishi Chemical | Wood | Powder | 981 |
| Example 4 | Burokoru-B | Taihei Chemical Industrial | Coal | Powder | — |
| Comparative | Filtrasorb 400 | Calgon Mitsubishi Chemical | Coal | Granular | 1064 |
| Example 1 | | | | | |
| Comparative | Coconut-derived | Calgon Mitsubishi Chemical | Coconut | Granular | 2017 |
| Example 2 | Highly Activated Carbon | | | | |
| Comparative | Shirasagi WH2C | Japan EnviroChemicals | Coconut | Granular | 1272 |
| Example 3 | | | | | |
| Comparative | Kuraray Coal | Kuraray Chemical | Coal | Granular | — |
| Example 4 | KW 10/32 | | | | |
| Comparative | STL 820 | Calgon Mitsubishi Chemical | Coal | Granular | 1058 |
| Example 5 | | | | | |
| Comparative | OL 20 × 50 | Calgon Mitsubishi Chemical | Coal | Granular | 1092 |
| Example 6 | | | | | |

Powder: The particles having a size not larger than the 200 mesh size (sieve opening 0.075 mm) is not smaller than 90% by mass of the total particles.
Granular: The particles having a size not larger than the 200 mesh size (sieve opening 0.075 mm) is smaller than 90% by mass of the total particles.

TABLE 2

| | | | | | Specific surface |
|---|---|---|---|---|---|
| | Trade name | Manufacturer | Raw material | Form | area (m²/g) |
| Example 5 | Shirasagi DO-2 | Japan EnviroChemicals | Coconut | Powder | 940 |
| Example 6 | Shirasagi DO-2 | Japan EnviroChemicals | Coconut | Powder | 940 |
| Comparative | Filtrasorb 400 | Calgon Mitsubishi Chemical | Coal | Granular | 1064 |
| Example 7 | | | | | |
| Comparative | Filtrasorb 400 | Calgon Mitsubishi Chemical | Coal | Granular | 1064 |
| Example 8 | | | | | |
| Comparative | Coconut-derived | Calgon Mitsubishi Chemical | Coconut | Granular | 2017 |
| Example 9 | Highly Activated Carbon | | | | |
| Comparative | Coconut-derived | Calgon Mitsubishi Chemical | Coconut | Granular | 2017 |
| Example 10 | Highly Activated Carbon | | | | |
| Comparative | Shirasagi WH2C | Japan EnviroChemicals | Coconut | Granular | 1272 |
| Example 11 | | | | | |
| Comparative | Shirasagi WH2C | Japan EnviroChemicals | Coconut | Granular | 1272 |
| Example 12 | | | | | |

Powder: The particles having a size not larger than the 200 mesh size (sieve opening 0.075 mm) is not smaller than 90% by mass of the total particles.
Granular: The particles having a size not larger than the 200 mesh size (sieve opening 0.075 mm) is smaller than 90% by mass of the total particles.

TABLE 3

| | | Activated | | PFOA |
|---|---|---|---|---|
| | Stirring time | carbon | Aqueous PFOA | concentration |
| | (hours) | (g) | solution (g) | (ppb) |
| Example 1 | 0 | 0.00 | — | 786.2 |
| | 168 | 0.05 | 100 | 0.5 |
| | 168 | 0.10 | 100 | 0.1 |
| | 168 | 0.15 | 100 | 0.2 |
| Example 2 | 0 | 0.00 | — | 515.3 |
| | 168 | 0.05 | 100 | 3.0 |
| | 168 | 0.10 | 100 | 0.2 |
| | 168 | 0.15 | 100 | 0.1 |
| Example 3 | 0 | 0.00 | — | 515.3 |
| | 168 | 0.05 | 100 | 1.0 |
| | 168 | 0.10 | 100 | 0.4 |
| | 168 | 0.15 | 100 | 0.2 |
| Example 4 | 0 | 0.00 | — | 515.3 |
| | 168 | 0.05 | 100 | 0.5 |
| | 168 | 0.10 | 100 | 0.2 |
| | 168 | 0.15 | 100 | 0.1 |
| Comparative | 0 | 0.00 | — | 515.3 |
| Example 1 | 168 | 0.05 | 100 | 217.8 |
| | 168 | 0.10 | 100 | 149.1 |
| | 168 | 0.15 | 100 | 87.6 |
| Comparative | 0 | 0.00 | — | 786.2 |
| Example 2 | 168 | 0.05 | 100 | 128.1 |
| | 168 | 0.10 | 100 | 6.2 |
| | 168 | 0.15 | 100 | 7.8 |
| Comparative | 0 | 0.00 | — | 515.3 |
| Example 3 | 168 | 0.05 | 100 | 189.4 |
| | 168 | 0.10 | 100 | 182.6 |
| | 168 | 0.15 | 100 | 8.4 |
| Comparative | 0 | 0.00 | — | 786.2 |
| Example 4 | 168 | 0.05 | 100 | 272.6 |
| | 168 | 0.10 | 100 | 20.3 |
| | 168 | 0.15 | 100 | 15.4 |
| Comparative | 0 | 0.00 | — | 786.2 |
| Example 5 | 168 | 0.05 | 100 | 251.3 |
| | 168 | 0.10 | 100 | 269.7 |
| | 168 | 0.15 | 100 | 142.2 |
| Comparative | 0 | 0.00 | — | 786.2 |
| Example 6 | 168 | 0.05 | 100 | 180.2 |
| | 168 | 0.10 | 100 | 16.3 |
| | 168 | 0.15 | 100 | 21.9 |

TABLE 4

| | | Activated | | PFOA |
|---|---|---|---|---|
| | Stirring time | carbon | Aqueous PFOA | concentration |
| | (hours) | (g) | solution (g) | (ppb) |
| Example 5 | 0 | 0.00 | — | 5100.0 |
| | 168 | 0.06 | 100 | 0.4 |
| | 168 | 0.10 | 100 | 0.4 |
| Example 6 | 0 | 0.00 | — | 10000.0 |
| | 168 | 0.06 | 100 | 1.3 |
| | 168 | 0.10 | 100 | 0.6 |
| Comparative | 0 | 0.00 | — | 5100.0 |
| Example 7 | 168 | 0.06 | 100 | 451.0 |
| | 168 | 0.10 | 100 | 211.9 |
| Comparative | 0 | 0.00 | — | 10000.0 |
| Example 8 | 168 | 0.06 | 100 | 453.2 |
| | 168 | 0.10 | 100 | 303.1 |
| Comparative | 0 | 0.00 | — | 5100.0 |
| Example 9 | 168 | 0.06 | 100 | 93.3 |
| | 168 | 0.10 | 100 | 31.5 |
| Comparative | 0 | 0.00 | — | 10000.0 |
| Example 10 | 168 | 0.06 | 100 | 413.3 |
| | 168 | 0.10 | 100 | 126.3 |
| Comparative | 0 | 0.00 | — | 5100.0 |
| Example 11 | 168 | 0.06 | 100 | 70.3 |
| | 168 | 0.10 | 100 | 10.0 |
| Comparative | 0 | 0.00 | — | 10000.0 |
| Example 12 | 168 | 0.06 | 100 | 376.0 |
| | 168 | 0.10 | 100 | 28.4 |

### Example 7 to 9

The same activated carbon as the example 1 (product of Japan EnviroChemicals, Ltd., trademark: Shirasagi DO-2) was employed and subjected to the same pretreatment mentioned above, and then was used for the treatment of the aqueous solution of PFOA.

### Preparation of the Aqueous Solution of PFOA

PFOA (product of Aldrich Chemical Company; purity 96%) was dissolved in pure water to give the aqueous solutions. Each PFOA concentration thereof is given in table 5.

### Treatment of the Aqueous PFOA Solution

The procedure of Example 1 was repeated in the same manner except that the treatment conditions were varied as given in Table 5. The results obtained in the examples are shown in Table 5 and FIG. 3.

TABLE 5

| | | Activated | | PFOA |
|---|---|---|---|---|
| | Stirring time | carbon | Aqueous PFOA | concentration |
| | (minutes) | (g) | solution (g) | (ppb) |
| Example 7 | 0 | 0.00 | — | 284.3 |
| | 60 | 0.03 | 200 | 0.8 |
| Example 8 | 0 | 0.00 | — | 291.3 |
| | 60 | 0.04 | 200 | 0.9 |
| Example 9 | 0 | 0.00 | — | 266.1 |
| | 60 | 0.05 | 200 | 1.4 |

### Experiment Example 1

The aqueous PFOA solution treatment procedure of Comparative Example 1 was followed in the same manner except that the activated carbon addition level was varied. The results obtained are shown in Table 6 and FIG. 4.

TABLE 6

| | | Activated | Aqueous | PFOA |
|---|---|---|---|---|
| | Stirring time | carbon | PFOA | concentration |
| Trade name | (hours) | (g) | solution (g) | (ppb) |
| Filtrasorb 400 | 0 | 0.00 | — | 515.3 |
| Filtrasorb 400 | 168 | 0.05 | 100 | 217.8 |
| Filtrasorb 400 | 168 | 0.10 | 100 | 149.1 |
| Filtrasorb 400 | 168 | 0.15 | 100 | 87.6 |
| Filtrasorb 400 | 168 | 0.20 | 100 | 90.0 |

The results shown in Table 6 and FIG. 4 revealed that, in the case of the granular activated carbon, there is a limit on the extent of reduction in fluorinated surfactant concentration even when the activated carbon addition level is increased.

### INDUSTRIAL APPLICABILITY

The treatment method of the invention can be suitably utilized for the treatment and purification of industrial waste water, among others.

1. A treatment method
comprising a step (1) of contacting a water to be treated containing 100 to 10000 ppb of a fluorinated surfactant with an activated carbon and
a step (2) of obtaining a treated water containing not more than 3.0 ppb of the fluorinated surfactant,
wherein the activated carbon comprises particles capable of passing through a 75-μm filter of not smaller than 90% by mass of the total particles.

2. The treatment method according to claim 1,
wherein the step (2) is a step of obtaining a treated water containing not more than 0.4 ppb of the fluorinated surfactant.

3. The treatment method according to claim 1,
wherein the fluorinated surfactant is at least one species selected from a group consisting of perfluorooctanoic acid, perfluorooctanoic acid salts, perfluorooctanesulfonic acid and perfluorooctanesulfonic acid salts.

4. The treatment method according to claim 1,
wherein the activated carbon is added in an amount not smaller than 0.015% by mass of the water to be treated.
